(19) United States
(12) Patent Application Publication
(10) Pub. No.: US 2020/0026881 A1
(43) Pub. Date: Jan. 23, 2020

(54) SYSTEMS AND METHODS FOR PERFORMING AUTHENTICATION

(71) Applicant: Glenn Cobourn Everhart, Smyrna, DE (US)

(72) Inventor: Glenn Cobourn Everhart, Smyrna, DE (US)

(21) Appl. No.: 12/147,167

(22) Filed: Jun. 26, 2008

(51) Int. Cl. G06F 21/72; G06F 16/31

(52) U.S. Cl. CPC G06F 21/72; G06F 16/325

(57) ABSTRACT

The invention provides systems and methods of authenticating to determine that memory of a remote device contains known processing code, in conjunction with performing a financial transaction, the remote device operated by a customer. The method may include receiving transaction data from the remote device, the transaction data related to a requested financial transaction; inputting device identification information from the remote device; selecting at least one query, based on the device identification information; sending the at least one query to the remote device, the query probing attributes of the software of the remote device; inputting a query response, which constitutes a response to the query, from the remote device; performing a validity test including comparing the query response with an expected query response; and based on the comparing, determining whether the validity test is passed, and (1) outputting approval of the requested financial transaction if the validity test is passed; and (2) outputting disapproval of the requested financial transaction if the validity test is not passed.

### BACKGROUND OF THE INVENTION

The invention relates to performing authentication associated with a transaction where the authentication is done using a remote user programmable device.

User programmable devices have long been attractive as payment devices due to their possession of robust input, output, and networking support enabling machine assistance to the payment process. However, it has been generally infeasible to ensure that the device is does not contain software which can tamper with, duplicate, or alter transactions without knowledge of the person trying to do a payment.

The systems and methods of the invention address at least these shortcomings of the known art.

### BRIEF SUMMARY OF THE INVENTION

The invention provides systems and methods of authenticating to determine that memory of a remote device contains known processing code, in conjunction with performing a financial transaction, the remote device operated by a customer. The method may include receiving transaction data from the remote device, the transaction data related to a requested financial transaction; inputting device identification information from the remote device; selecting at least one query, based on the device identification information; sending the at least one query to the remote device, the query probing attributes of the software of the remote device; inputting a query response, which constitutes a response to the query, from the remote device; performing a validity test including comparing the query response with an expected query response; and based on the comparing, determining whether the validity test is passed, and (1) outputting approval of the requested financial transaction if the validity test is passed; and (2) outputting disapproval of the requested financial transaction if the validity test is not passed.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a block diagram of a transaction system containing a secure processor portion (120), in accordance with one embodiment of the invention;

FIG. 2 is a block diagram showing further details of the transaction system of FIG. 1, in accordance with one embodiment of the invention;

FIG. 3 is a high level flowchart showing a transaction process using a novel authentication approach, in accordance with one embodiment of the invention;

FIG. 4 is a flowchart showing further details of the “generation of an authentication response” step of FIG. 3, in accordance with one embodiment of the invention;

FIG. 5 is a flowchart showing further details of the “generation of an authentication response” step of FIG. 3, in accordance with a further embodiment of the invention;

FIG. 6 is a flowchart showing further details of the “generation of an authentication response” step of FIG. 3, in accordance with a yet further embodiment of the invention;

FIG. 7 is a flowchart showing further details of the “generation of an authentication response” step of FIG. 3, in accordance with a yet further embodiment of the invention;

FIG. 8 is a flowchart showing further details of the “interface with a user” processing of FIGS. 4-6, respectively, in accordance with an embodiment of the invention;

FIG. 9 is a flowchart showing further details of the “perform device authentication” processing of FIGS. 4-6, respectively, in accordance with a yet further embodiment of the invention;

FIG. 10 is a flowchart showing further details of the “processing of a checksum authentication query” processing of FIG. 9, in accordance with a further embodiment of the invention;

FIG. 11 is a flowchart showing further details of the “processing of a checksum authentication query” processing of FIG. 9, in accordance with a yet further embodiment of the invention;

FIG. 12 is a flowchart showing further details of the “processing of a checksum authentication query” processing of FIG. 9, in accordance with a yet further embodiment of the invention; and

FIG. 13 is a block diagram showing a variation of the transaction system of FIGS. 1 and 2, in accordance with one embodiment of the invention.

### DETAILED DESCRIPTION OF THE INVENTION

Hereinafter, aspects in accordance with various embodiments of the invention will be described. As used herein, any term in the singular may be interpreted to be in the plural, and alternatively, any term in the plural may be interpreted to be in the singular.

The present invention provides techniques which allow use of remote devices in two cases in particular, in accordance with embodiments of the invention.

The first of these cases is where the remote device contains some special hardware able to reliably keep a secret value and compute with such secret value, and where a hardware trusted path exists to allow this special hardware to communicate with a display, and in turn the customer. The present invention describes how to achieve secure input from a customer using such an arrangement, even though input channels are subject to interception or monitoring.

The second of the illustrative cases deals with remote devices with no hardware security at all (or limited hardware security) and gives a method for ensuring the absence of intercepting software and suggestions for how a platform so validated can then be used for customer authentication and transaction authorization.

Where the remote device contains a secure processor able to handle secrets, and a trusted hardware path to a display, the invention provides a way to achieve secure user input. In accordance with one embodiment of the invention, this is accomplished by display of a series of glyphs in some spatial pattern, so that the secure processor generates a new display every time it is used, and by having the customer select some of the glyphs in an order remembered by the customer. These selected glyphs can then be entered via keyboard or other input channels. Because the underlying display changes every time, and cannot be monitored by the main remote processor (since this is a trusted hardware path), the glyphs selected will change every time a display is to be entered. So long as the secure processor shares a secret with an authenticator, the authenticator can duplicate the secure processor's display generation and validate the selected glyphs. Because the selection pattern does not appear directly in key-in input, too, rogue software observing inputs learns nothing useful in predicting valid inputs. Other analogous selection can be done to permit a customer to select glyphs based on transaction characteristics (e.g., amount) and again the input entered does not give information about the “signing” being done, but appears as yet another one-time data pattern. Thus the input is in effect secure, even though it can be monitored, because the underlying meaning of the input is hidden from any rogue software (or people receiving copies of data).

Where a remote device contains no underlying hardware security (which is not uncommon of various devices in the field currently), the invention provides for a manner to check that the device is not infected with unwanted software. (This feature in effect helps authenticate the device, and makes subsequent authentication of the customer possible.)

The invention provides for this action by adding a conversation between an authenticating back end system and the remote device which is able to read and return contents of small areas of memory and to compute a cryptographic checksum of memory (or multiple checksums of memory) in the remote device between bounds furnished by the back-end system.

To explain further, the back end computer is likely, in some embodiments, to need to read a few areas of software in the remote device. This is so the backend system (e.g. the authentication entity 300) can determine what software is loaded on the remote device, and where such software is loaded on the remote device, i.e., when the particular software/location is not fixed (or known by the backend system) ahead of time. Any software in the remote device may be checked using the various processes and systems described herein, as well as software disposed between the remote device and the backend system.

As described above, the bounds of areas in the software checked may be varied. By varying the bounds selected, the back end can ensure there are too many combinations of bounds for rogue software to pre-compute (i.e. to a degree deemed sufficient), and can check all (or a sufficient portion of) memory used in the remote device which is needed for the control of the data paths between customer, network, and input/output devices to ensure its crypto checksum values match what un-infected systems should have. In effect, the back end asks a set of questions of the system. While an uninfected remote device need only reply with the truth, it can be made arbitrarily hard for a remote system to lie consistently about its contents. Also, any attack which evades a short question list can be adapted to by adding appropriate new questions to the setup. When these transactions are done (a process which would take a fraction of a second to finish) further processing can be used to allow the remote platform to be used to authenticate the user. Some of this processing can be similar to that used in the first case, so that customer action will demonstrate customer (as opposed to device only) is present and identified correctly, yet produce results which if picked up on wiretaps or the like will not be useful to intruders.

The invention provides a novel communication and authentication platform. In particular, the invention might be embodied in the form of a cell phone, as described below, but may well be embodied in various other communication devices, such as PDAs. The invention provides novel approaches to perform authentication for transactions and to confirm the identity of a cell phone (or other personal device), for example.

Cell phones and other communication platforms are gaining popularity as payment platforms. Various authentication processing is used in conjunction with such a payment platform. Such authentication processing may be used to effect a transaction, for example. However, there are problems associated with using a common processor for both the communication processing and for the authentication processing. In particular, worms and other nefarious programs can gain access to the common processor via the communication channel of the device. These nefarious programs can then effect or assist in fraudulent transactions. The invention addresses these problems and others.

In a communication device, in accordance with one embodiment of the invention, such as a cell phone, the invention provides dual processors to perform the communication processing and the authentication processing, respectively. The authentication processing may also include device confirmation processing, e.g. using cryptographic hash functions. Various related features are also provided by the invention.

If such dual processors include a secure processor with a trusted path to a display, a customer (user of the phone) can enter data not useful to the phone's communication processor-by use of customer selection of parts of a displayed value and entry of the same, where the displayed value is generated securely within the auxiliary processor.

In embodiments, dual processors may be utilized in such a manner to include a secure processor with a trusted path to a display. A customer (user of the phone) can enter data not seen or useful to the phone's communication processor. As a result, the secure processor, i.e., the authentication processor, in the phone can interface with the customer to perform authentication related processing. The secure processor can then interface with the communication processor, in a controlled manner, so as to effect the desired authentication/transaction. Alternatively, the secure processor may interface directly with a merchant and/or an authentication entity.

In another embodiment, a single processor may be used, but in such a manner that the lines of communication afforded to the single processor is controlled. That is, for example, the processor may be provided to only alternatively access (1) the authentication memory in the phone, and (2) the communication memory in the phone, i.e., to be in authentication mode and communication mode, respectively. A flip-flop or toggle switch may be provided to control which mode the cell phone is in. Information generated in authentication mode may be passed to communication mode in a very controlled manner.

Hereinafter, further aspects of the invention will be described relating to authentication and the use of cryptographic hash functions to ensure the remote device is free of software that would tamper with data paths used to communicate with the customer or for other authentication and authorization purposes.

As described herein, when trying to perform financial transactions using a mobile device (such as a cell phone), avoiding fraudulent use requires some authentication. Characteristics desired in such authentication include:

Validate that the device is the one expected (and not a fake).

Validate that the customer is the one expected (not someone who found a lost phone, or a thief, for example).

Be able to demonstrate to the customer, conclusively, that he/she is talking to the bank (or the merchant he/she expects).

Ensure that authentication credentials cannot be stolen or replayed.

Allow confirmation by the customer that he/she accepts transaction details wherever the risk in a transaction warrants it.

Normal cell phones make this all difficult because they have no memory protection, yet are connected to networks and can be loaded with user specified programs. Thus there is nowhere to hide a secret on the cell phone, and malware programs can in principle watch everything users type and everything shown for them to see on a display.

The malware threat can be dealt with if a piece of software on a remote device can be placed there and communicate with the issuer's secure backend, i.e., a authentication entity 300 as described below. In accordance with one embodiment of the invention, device confirmation may be performed. Such processing may include a small applet or the like, which would be able to retrieve small blocks of memory from the mobile device, or be given a pair of addresses (in the memory of the cell phone) and return a cryptographic hash of the mobile device memory between those addresses.

The backend system would then, once it learns the identity of the mobile device, send a few queries (cryptographic hash functions) to that device asking for a crypto hash value of a portion of its memory, using varying address limits to make precomputation of the checksums by malware infeasible.

This can be done by asking for memory hash value, i.e., checksums, using at least one variable boundary Thus, if we learn that the critical path software for display is between address 5000 and 20000 in the cell phone memory, we can pick a boundary between these. For sake of illustration, let the boundary be 6230; then, we would ask two checksums, one between 5000 and 6230, and another between 6230 and 20000. We can pick this boundary as any of 15000 values, and can add other boundaries for other queries, making pre-storage of such by any malware hard.

In accordance with one embodiment of the invention, the authentication entity 300 might compute a few new cryptographic hash functions every day. Such would lessen the work at the authentication entity 300, without making malware authors' problems noticeably less. A few queries to read internal table addresses to find where critical software was loaded on a mobile phone, followed by a few memory checksum queries, i.e., cryptographic hash functions, would require only a small amount of traffic—perhaps a hundred packets—which would not be noticeable for a customer. Nevertheless, the use of a cryptographic hash function, as described herein, allows a backend processor to establish that memory holding the code that accesses display and keypad is unaltered.

Now of course to do this, the backend needs to know hardware and software configurations for cell phones, enough to do the cryptographic hash functions and related comparisons. These would be easy for vendors to generate (i.e., the authentication entity 300), but would be needed. Note too that this function makes it harder to emulate a phone and still authenticate.

As used herein, the term “checksum” is intended to mean (and/or be used interchangeably with) a cryptographic hash function, crypto hash, hash code, hash, generalized checksum, generalized hash, generalized cipher, and/or another similar process that utilizes information/data from a device (such as a cell phone), applies a computation to that data, and checks the result of the computation against an anticipated result. The anticipated result may well be typically calculated at some backend system.

If prior to further access, the checking of the cell phone is performed (as described herein), the authentication entity 300, merchant, etc. gains assurances the mobile device is intact and in a known state. Note too that if new malware be devised which evades these checks, the checks can be altered to detect it, without need to reprogram anything in the field. This allows exceedingly nimble correction of lapses in malware detection.

To authenticate a device (i.e., confirm the identity of a device), we must use only the memory it has, and since that is readable by transient malware (that loads, runs, and cleans up itself) we cannot expect too much. However, it is feasible to put some “secret” part of a key into a mobile device, possibly in some obscured form, but at runtime supplement it with:

Any observable numbers available over the network which can be checked (e.g., SIM serial numbers, phone number), and

A variable number generated at the backend and sent (over encrypted channel) to the mobile device. These parameters, i.e., the observable number or the variable number, can be used as a key to generate a “random” display to show the customer. This display would be the basis for belief (aside from the checking of software integrity above) that the device was the one expected. In other words, the observable number or the variable number (or a number from a counter) may be sent to a device, e.g. a phone, such that the device uses that number in part of its computation. For example, the number might be used in conjunction with performing the checksum (and taking the checksum and the observable number or the variable number, and performing some computation). The result of such computation would then be checked at the authentication entity 300, for example.

To use this display we might reasonably ask the customer to remember 4 positions in some order on the display. Suppose the display is a 3 by 3 grid of digits labeled A through I:

A B C
D E F
G H I

We might ask the customer to pick out 4 positions in some order and remember them.

Then to enter a login, instead of a password, one uses the key above, whose components are computable by the backend, to make up a 3 by 3 display of digits.

3 . . . 6 . . . 1

2 . . . 8 . . . 5

0 . . . 4 . . . 7

as an example. Now if the customer picked positions BEG A as his pattern, he would pick out digits 6, 8, 0, and 3 and enter those as his password (or PIN if you prefer to think of it that way). We can of course have the letters visible near the digits too, to make this easier, and this display can be linear instead of in a grid if we like. The same principles apply.

Related authentication techniques are described in U.S. patent application Ser. No. 11/137,409 filed May 26, 2005 (Attorney Docket No. 47004.000322) which is incorporated by reference herein in its entirety. Indeed, any of the features described in such application may be used in conjunction with any of the features described herein.

If we want to convince a customer he is connected to the right merchant or bank, we can tell him to generate a new “random” display and tell him what it will be ahead of time, quite apart from any other reasons he may have for believing this. Such a display is less bulletproof than it would be on a display card, but has some value.

A customer who enters a pattern selection from a display like this gives good evidence that he (or she) is the person claimed, and the correct digits are only available if the right secrets and serials AND the right pattern are all present. Because the final part of the key comes from the backend and is variable, such responses cannot be predicted from information in a mobile device alone. Nor does repeating them serve any purpose since they change and (as long as the backend is set to reject duplicates) would not be accepted.

After a transaction, it may be desired to get a confirmation from the customer. Here again, we can display something about a transaction like a total amount, and ask the customer to select positions on a display corresponding to the digits of the amount. Use of the same device he authenticated with moments before to encode amount, using the same device-resident information, gives evidence the customer accepts the amount. (Alternatively one can ask customer to enter his PIN again encoded in the way he did before (but with a new “random” display), and perhaps the amount in the clear, but it may be preferred to encode the amount using the random number just to make it harder for a program to forge a response.)

In accordance with one embodiment of the invention, the PINs passed on the network are one-time numbers, carrying 2 authentication factors, so it does not matter if they are intercepted or recorded.

A payment device that worked like this could do a number of useful things. Among them could be display of balances of various things—points, stored values for stored value devices, total charged for the month on a credit card, available credit, or the like. Once it was available, it could serve as a way to check authenticity of a mail by passing a number in an email, and arranging a phone display, once the authentication steps had been done, which could confirm such mail was in fact sent. It might authenticate other things too in generally similar fashion, a possible new source of revenue.

Customer experience would be not very different from that where he enters a PIN to log in, except that he picks it out using his pattern on a display. None of the traffic described herein would take longer than a fraction of a second to finish, too quick to notice for humans. Also the picking out scheme was understood in focus groups immediately by a substantial majority of the participants even based on a crude printed description and some conversation, and would not be a barrier to the rest since they have no model that suggests to them that somehow they should be known based only on their phone. This is easier than opening a car door. This offers a new service, so direct comparisons with credit cards should not be made.

In order to demonstrate to users that this processing is more secure than a system that just asks for a pattern and does no checking is an effort that might deserve some attention; maybe the screen color could change a little to indicate a successful platform checkout—turn it light green in background or something . . . maybe even by degrees. Ideally it is desirable to be able to make sure nothing else new runs until the banking app is done, or make the banking app exit if something else runs. Such processing is not required, but can be useful as a human factors aid to customers so they will be alerted that the platform has been checked out and passed the checks. This can assist them in avoiding faked devices or sites slightly.

The backend, i.e., the authentication entity 300, needs to know enough about software and phone models to know where to do the crypto checksums, i.e., the cryptographic hash function, and what they ought to be, so vendor agreements to keep that information current would typically be needed, in accordance with one embodiment of the invention. Note too that while customer authentication can be passed back as a PIN or (with 3 digits) as a CVV or CVV2 (CVC/CVC2) so existing payment messages can be used, the full authentication scope would presume some new platforms handling the messaging up front. That might need to have cell provider cooperation too.

One advantage of various features described herein, is that no hardware changes are needed, yet it gives the prospect of good security and some new services. The invention can be implemented with phones in the field today.

Indeed, even if a secure chip exists in a mobile platform, too, as long as there is not also a secure path from keyboard to secure chip and/or secure path from secure chip to display, the invention would provide noticeable benefits. That is, the code checking system, as described herein, will still be desirable, lest malware intercept customer inputs and outputs and be used to forge responses. Such a device would make identity of the device more strongly known.

As described herein, the systems and methods of embodiments of the invention use a cryptographic hash function. A cryptographic hash function is a function, i.e., a transformation, that takes a particular input and returns a hash value. The hash value may then be checked against the hash value that was expected. In this manner, the validity of the particular input is checked. The hash value may also be characterized, and has been done herein, as a checksum or digest, for example. Further, references herein to checksums and related processing are intended to mean hash values and cryptographic hash functions, i.e., that ay of such three techniques may be used in such described processing.

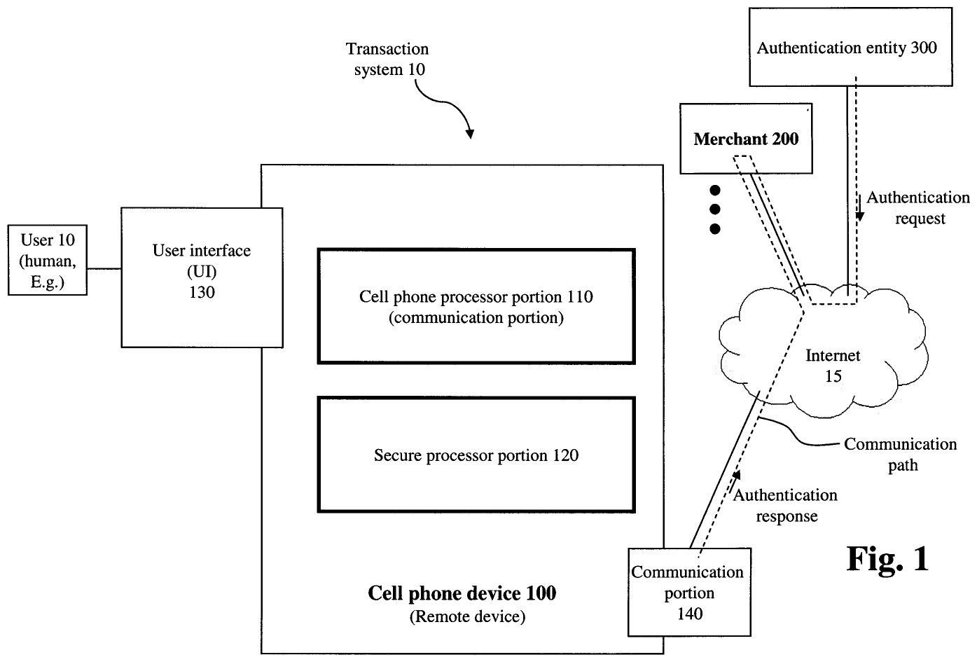

FIG. 1 is a block diagram of a transaction system, in accordance with one embodiment of the invention where a secure chip is available in the remote device. The transaction system 10 includes a cell phone device 100, a merchant 200, and an authentication entity 300. It is of course appreciated that the transaction system 10 may include any number of cell phone devices 100, as well as merchants 200 and authentication entities 300. In particular, there may well be thousands of cell phone devices 100 in the transaction system 10. The authentication entity 300 functions as a trusted authentication platform, and may take on a variety of forms. That is, the authentication entity 300 may be a stand alone authentication entity, for example. Alternatively, the authentication entity 300, i.e., the authentication platform, might be integrated into the processing system of a cell phone company, or some other company/third party, for example.

The cell phone device 100 includes various processing components. In particular, the cell phone device 100 includes a cell phone processor portion 110, an secure processor portion 120, a user interface 130 and a communication portion 140. The cell phone processor portion 110 handles the typical processing associated with a cell phone, such as effecting communications and the various features associated with the communications. Indeed, in accordance with one embodiment of the invention, the cell phone processor portion 110 may be in the form of a known, standard cell phone processing portion.

The secure processor portion 120 is a further processor in accordance with one aspect of the invention. The secure processor portion 120 is a different processor vis-á-vis the cell phone processor portion 110 in that the secure processor portion 120 is dedicated to handling authentication processing. As described below, the secure processor portion 120 is provided information (via the cell phone processor portion 110) and processes such information to perform authentication related processing. Once the authentication related processing is completed by the secure processor portion 120, the secure processor portion 120 outputs needed authentication related information to the cell phone processor portion 110 (so that such information may be output by the cell phone device 100 so as to authenticate a particular transaction). Various related processing may also be utilized, as described below. For example, access to user interfaces and memories in the cell phone device 100 may be selectively controlled between the cell phone processor portion 110 and the secure processor portion 120.

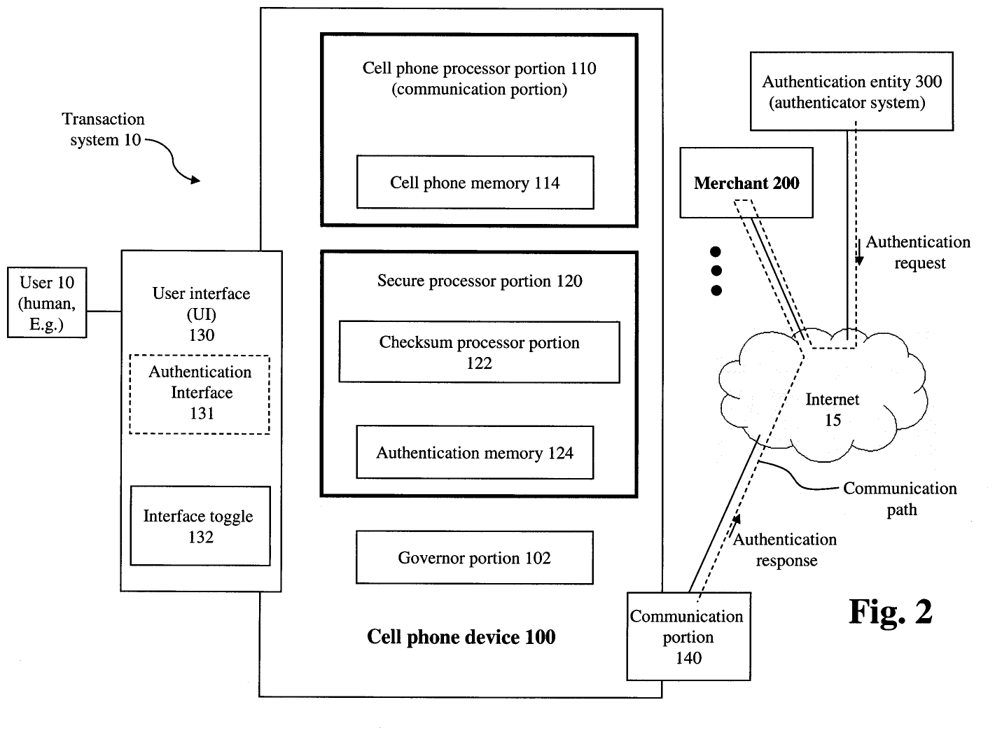

FIG. 2 is a block diagram showing further details of the transaction system of FIG. 1, in accordance with one embodiment of the invention.

As shown in FIG. 2, the cell phone processor portion 110 includes a cell phone memory 114. The cell phone memory 114 contains data that is used in the processing of the cell phone processor portion 110. On the other hand, the secure processor portion 120 includes the authentication memory 124. The authentication memory 124 contains data that is used in the processing of the secure processor portion 120. Data between the cell phone memory 114 and the authentication memory 124 is selectively exchanged, as described below. Accordingly, data in the authentication memory 124 is accessible by the cell phone processor portion 110 in a very limited manner. Such arrangement enhances the fraud prevention attributes of the cell phone device 100, as compared to traditional cell phones. In particular, authentication related data in the authentication memory 124 is not obtainable by a hacker hacking into the cell phone memory 114 (via the cell phone processor portion 110).

FIG. 2 also shows that the user interface 130 (in the cell phone device 100) includes an authentication interface 131. In accordance with one embodiment of the invention, the user interface 130 is usable by the cell phone processor portion 110, and the authentication interface 131 is usable by the secure processor portion 120. The interface toggle 132, in accordance with one embodiment of the invention, toggles between the user interface 130 being active/usable vis-a-vis the authentication interface 131 being active/usable. The interface toggle 132 may be in the form of a physical toggle switch that is manipulated by a user or an electronic toggle switch that is manipulated by the cell phone processor portion 110, the secure processor portion 120 or the governor portion 102. That is, the governor portion 102 is a further component of the cell phone device 100. The governor portion 102 may be provided to coordinate the complementary operations of the cell phone processor portion 110 and the secure processor portion 120.

The cell phone device 100 also includes a checksum processor portion 122. The checksum processor portion 122 performs checksum processing as described below.

The cell phone device 100 of FIG. 2 shows the authentication interface 131 in the user interface 130. However, it is appreciated that the user interface 130 and the authentication interface 131 might instead be fully different and independent interfaces.

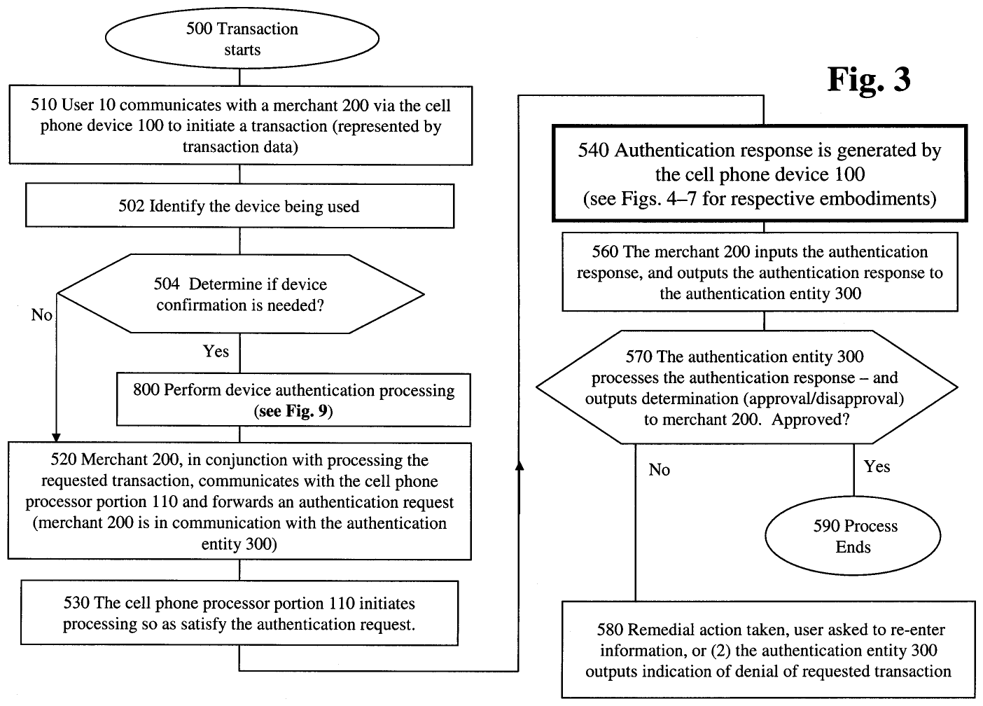

FIG. 3 is a high level flowchart showing a transaction process, in accordance with one embodiment of the invention.

In general, processing of a requested transaction includes a variety of steps, including several message/response pairs that traverse the particular network. For example, in accordance with one embodiment of the invention, there may be communications that initiate the transactions, then an identification of the device in question, then a variety of requests regarding device confirmation. The communications regarding device confirmation may include what to do, what memory to return, where to return the memory from, a request to return crypto checksum between low and high addresses, requests and responses, the request for a value in memory, a request for some other crypto checksum, and communications regarding checking of values at backend, i.e., at the authentication entity 300. Thereafter, customer authentication may be performed.

FIG. 3 is a flowchart showing some of such features.

The illustrative process of FIG. 3 starts in step 500 with the start of a requested transaction. Then, the process passes to step 510.

In step 510, the user 10 communicates with a merchant 200 via the cell phone device 100 to initiate a transaction. The initiated transaction is represented by “transaction data”.

Then, the process passes to step 502 as shown in FIG. 3, in accordance with one embodiment of the invention. In step 502, the device being used is identified, i.e., particulars of the device (such as a device serial number or some other particular of the customer device) is transmitted from the device to the authentication entity 300. Such transmission of the device particulars may be via the merchant 200. Then, after step 502 of FIG. 3, the process passes to step 504.

In step 504, the authentication entity 300 determines if device authentication is needed. This processing may include consideration of a variety of parameters including the value of the transaction, the frequency of the transaction vis-á-vis other transactions effected by the device, the type of device, the merchant through which the transaction is effected, and/or any other criteria. For example, if the transaction amount is below a particular threshold value and the transaction is not suspect in any way, then no device authentication may be required.

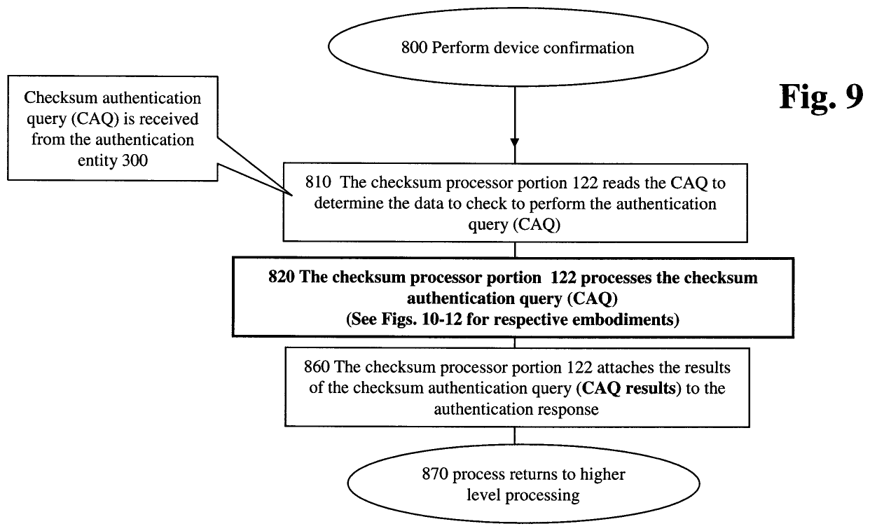

In step 504, if device authentication is needed, then the process passes to step 800. In step 800, device authentication processing is performed. Further details of the processing of step 800 are described below with reference to FIG. 9. After step 800 of FIG. 3, the process passes to step 520. On the other hand, if device authentication is determined to not be needed (in step 504, then the process passes directly to step 520.

Then, in step 520, the merchant 200, in conjunction with processing the requested transaction, communicates with the cell phone processor portion 110 and forwards an authentication request to the cell phone processor portion 110. The merchant 200 may well be in communication with the authentication entity 300, i.e., so as to generate the authentication request.

Then, in step 530, the cell phone processor portion 110 initiates processing so as satisfy the authentication. Then, the process passes to step 540.

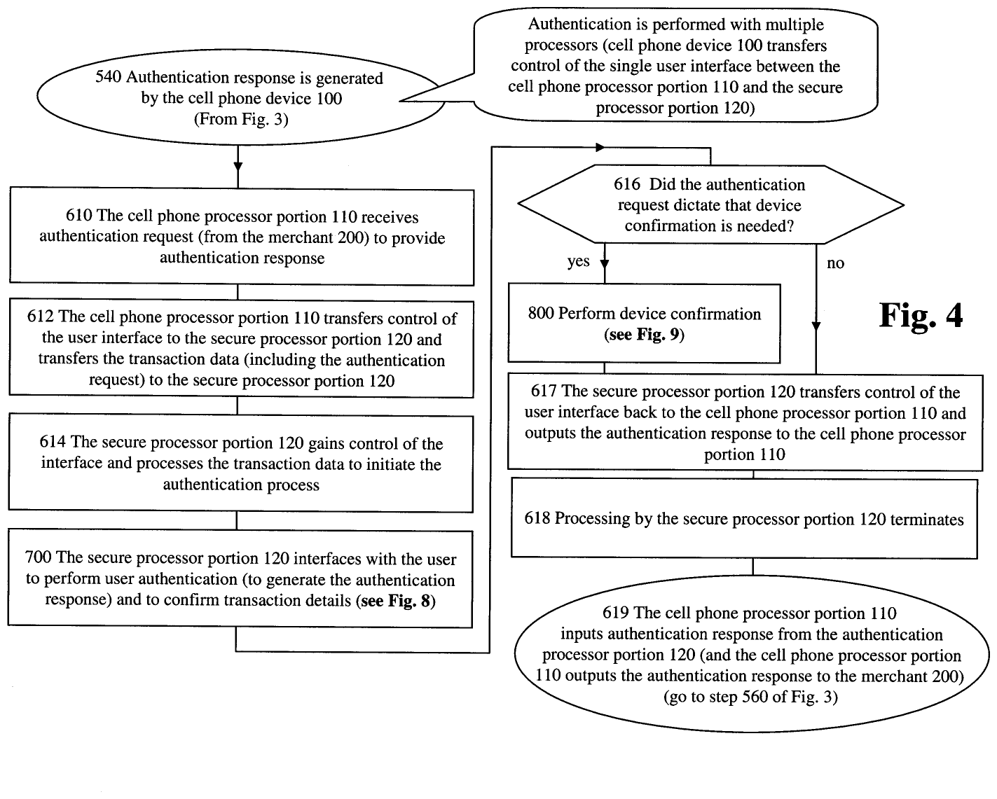

In step 540, an authentication response is generated by the cell phone device 100, so as to satisfy the authentication request. As described below, FIGS. 4-7 below show four respective embodiments of the processing of step 540.

After step 540 of FIG. 3, the process passes to step 560. In step 560, the merchant 200 inputs the authentication response (that has been generated by the cell phone device 100), and outputs the authentication response to the authentication entity 300.

In step 570, the authentication entity 300 processes the authentication response and outputs either an approval or disapproval determination back to merchant 200. If approved, the process passes to step 590, and the process ends with the transaction being approved. On the other hand, if not approved, the process passes to step 580.

In step 580, remedial action may be taken, such as the user asked to re-enter information, or (2) the authentication entity 300 simply outputs an indication of denial of the requested transaction.

FIG. 4 is a flowchart showing further details of the “generation of an authentication response” step of FIG. 3, in accordance with one embodiment of the invention. In the example of FIG. 4, authentication is performed with multiple processors. In particular, in this example, the cell phone device 100 transfers control of a single user interface between the cell phone processor portion 110 and the secure processor portion 120.

After starting in step 540, the subprocess passes to step 610. In step 610, the cell phone processor portion 110 receives the authentication request (from the merchant 200) to provide authentication response. Then, in step 612, the cell phone processor portion 110 transfers control of the user interface to the secure processor portion 120 and transfers the transaction data (including the authentication request) to the secure processor portion 120.

Then, in step 614, the secure processor portion 120 gains control of the interface and processes the transaction data to initiate the authentication process. The process then passes to step 700.

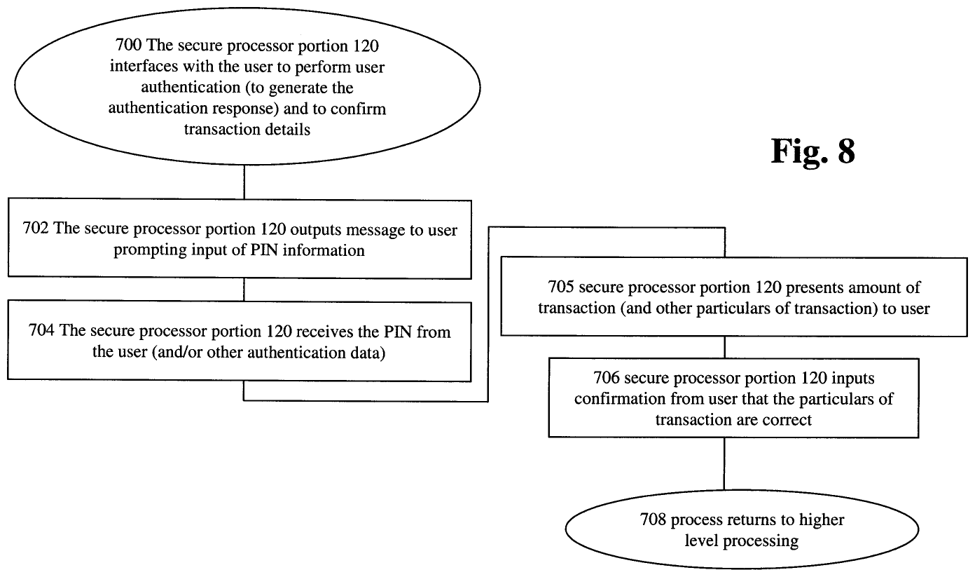

In step 700, the secure processor portion 120 interfaces with the user to perform user authentication (to generate the authentication response) and to confirm transaction details. Further details of the processing of step 700 are described below with reference to FIG. 8.

Then, the process passes to step 616. In step 616, the process, e.g. the secure processor portion 120, determines whether the authentication request, which was received, dictates that device confirmation was also needed. That is, as described above, device confirmation, i.e., device authentication, is a further authentication that may be performed, using checksum processing, to confirm that a legitimate device is effecting the transaction. As described above as steps 504 and 800 of FIG. 3, in some embodiments, the checksum processing may be performed shortly after initiating processing of a transaction (and before use authentication). However, step 616 and step 800 of FIG. 4 illustrate that such checksum processing may be performed at other points in the processing, as desired, Indeed, the checksum processing of FIG. 9 may be performed both before and after user authentication, if it is so desired.

Returning now to step 616 of FIG. 4, if yes in step 616, i.e., device confirmation is requested, the process passes to step 800, and such device confirmation is performed. Further details of the device confirmation of step 800 are described below. After step 800, the process passes to step 617, as shown in FIG. 4.

On the other hand, if in step 616 device authentication was determined to not be requested, then the process passes directly to step 617. In step 617, the secure processor portion 120 transfers control of the user interface, e.g. the user interface 130, back to the cell phone processor portion 110 and outputs the authentication response to the cell phone processor portion 110. Then, the process passes to step 618, and processing by the secure processor portion 120 terminates.

Thereafter, in step 619, the cell phone processor portion 110 inputs authentication response from the secure processor portion 120, and the cell phone processor portion 110 outputs the authentication response to the merchant 200. The process then goes to step 550 of FIG. 3. Alternatively, it is appreciated that the secure processor portion 120 may be provided so as to interface directly with the authentication entity 300 and/or the merchant 200.

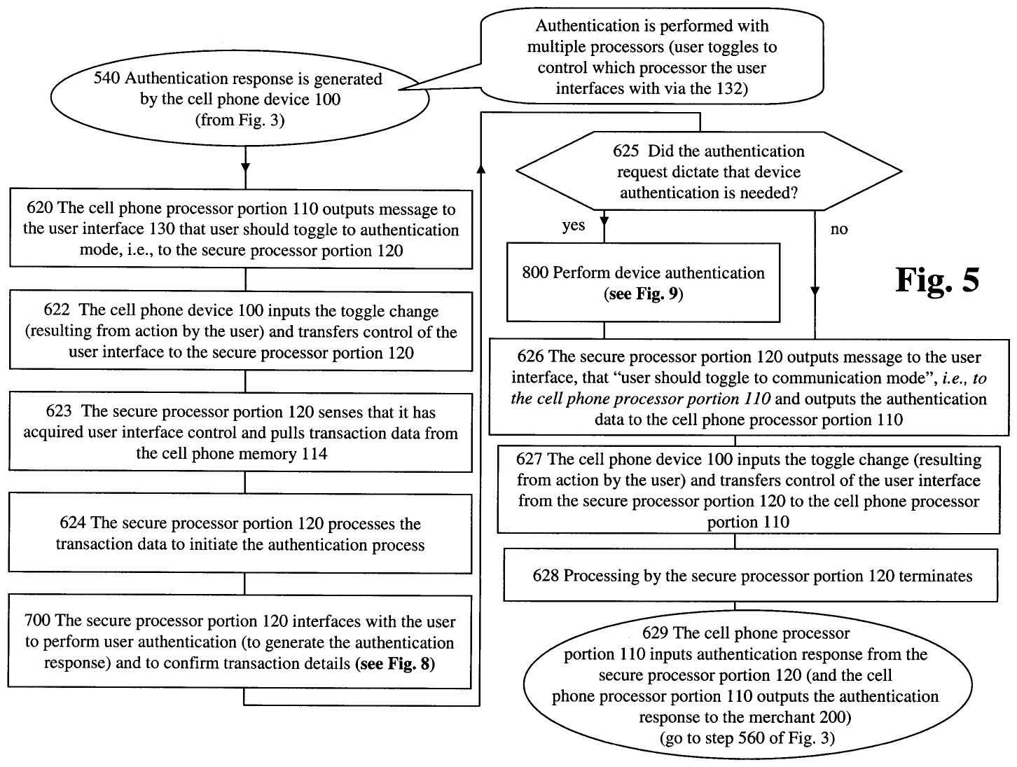

FIG. 5 is a flowchart showing further details of the “generation of an authentication response” step of FIG. 3, in accordance with a further embodiment of the invention. In the processing of FIG. 5, authentication is performed with multiple processors (and the user toggles the interface toggle 132 to control which processor the user interfaces with). That is, the user only uses the authentication interface 131, but toggles to dictate whether the user 10 interfaces with the cell phone processor portion 110 or the secure processor portion 120 (via the user interface 130).

The subprocess starts in step 540, and passes to step 620.

In step 620, the cell phone processor portion 110 outputs a message via the user interface 130 that the user 10 should toggle to “authentication mode”, i.e., to the secure processor portion 120. Then, in step 622, the cell phone device 100 inputs the toggle change (resulting from action by the user) and transfers control of the user interface 130 to the secure processor portion 120.

Then, in step 623, the secure processor portion 120 senses that it has acquired user interface control (i.e., control of the user interface 130) and pulls transaction data from the cell phone memory 114. Then, in step 624, the secure processor portion 120 processes the transaction data to initiate the authentication process.

In step 700, the secure processor portion 120 interfaces with the user to perform user authentication (to generate the authentication response) and to confirm transaction details. As noted above, such processing is further described below (with reference to FIG. 8).

After step 700 of FIG. 5, the process passes to step 625. In step 625, the process determines whether the authentication request dictated that device authentication is needed. If yes, the process passes to step 800, and such device authentication is performed. After step 800 of FIG. 5, the process passes to step 626.

On the other hand, if device authentication is not required, the process passes directly to step 626.

In step 626, the secure processor portion 120 outputs a message to the user interface, that “user should toggle to communication mode”, i.e., to the cell phone processor portion 110. Further, the secure processor portion 120 outputs the authentication data, which it has acquired, to the cell phone processor portion 110.

Then, in step 627, the cell phone device 100 inputs the toggle change (resulting from action by the user) and transfers control of the user interface 130 from the secure processor portion 120 back to the cell phone processor portion 110.

In step 628, processing by the secure processor portion 120 terminates. Then, in step 629, the cell phone processor portion 110 inputs the authentication response from the secure processor portion 120 (and the cell phone processor portion 110 outputs the authentication response to the merchant 200). The process then goes to step 550 of FIG. 3.

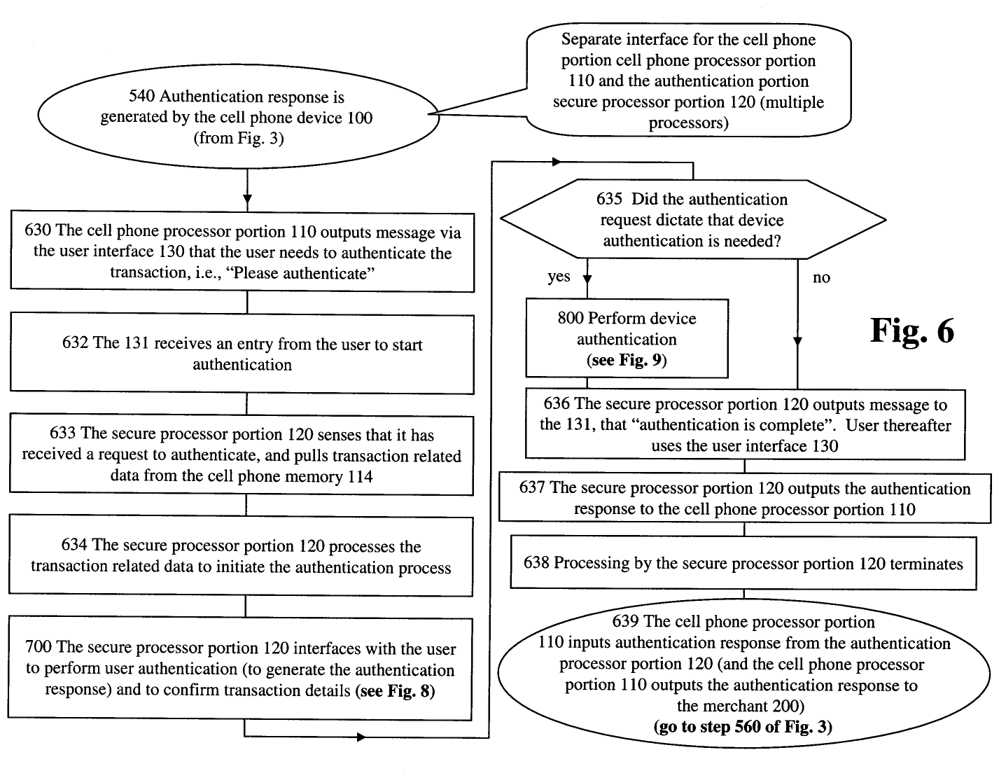

FIG. 6 is a flowchart showing further details of the “generation of an authentication response” step of FIG. 3, in accordance with a yet further embodiment of the invention. In the processing of FIG. 6, separate interfaces are provided for the cell phone portion cell phone processor portion 110 and the authentication portion secure processor portion 120. That is, the user toggles between the user interface 130 (to interface with the cell phone processor portion 110) vis-á-vis the authentication interface 131 (to interface with the secure processor portion 120).

The process of FIG. 6 starts in step 540, and passes to step 630. In step 630, the cell phone processor portion 110 outputs a message via the user interface 130 that the user needs to authenticate the transaction, i.e., “Please authenticate”. In step 632, the authentication interface 131 receives an entry from the user to start authentication. I.e., the user 10 knows to use the authentication interface 131 to authenticate. Then, the process passes to step 633.

In step 633, the secure processor portion 120 senses that it has received a request to authenticate, and pulls transaction related data from the cell phone memory 114. In step 634, the secure processor portion 120 processes the transaction related data to initiate the authentication process. In step 700, the secure processor portion 120 interfaces with the user to perform user authentication (to generate the authentication response) and to confirm transaction details, as described below with reference to FIG. 8.

After step 700, the process passes to step 635. In step 635, the process determines whether the authentication request dictated that device authentication is needed. If yes, the process passes to step 800, and such device authentication is performed. After step 800 of FIG. 6, the process passes to step 636.

On the other hand, if device authentication is not required, the process passes directly to step 636.

In step 636, the secure processor portion 120 outputs a message to the authentication interface 131, that “authentication is complete”. The user thereafter uses the user interface 130, to perform further communication as desired. In step 637, the secure processor portion 120 outputs the authentication response to the cell phone processor portion 110. Then, in step 638, processing by the secure processor portion 120 terminates. After step 638, the process passes to step 639.

In step 639, the cell phone processor portion 110 inputs the authentication response from the secure processor portion 120 (and the cell phone processor portion 110 outputs the authentication response to the merchant 200). The process then goes to step 550 of FIG. 3.

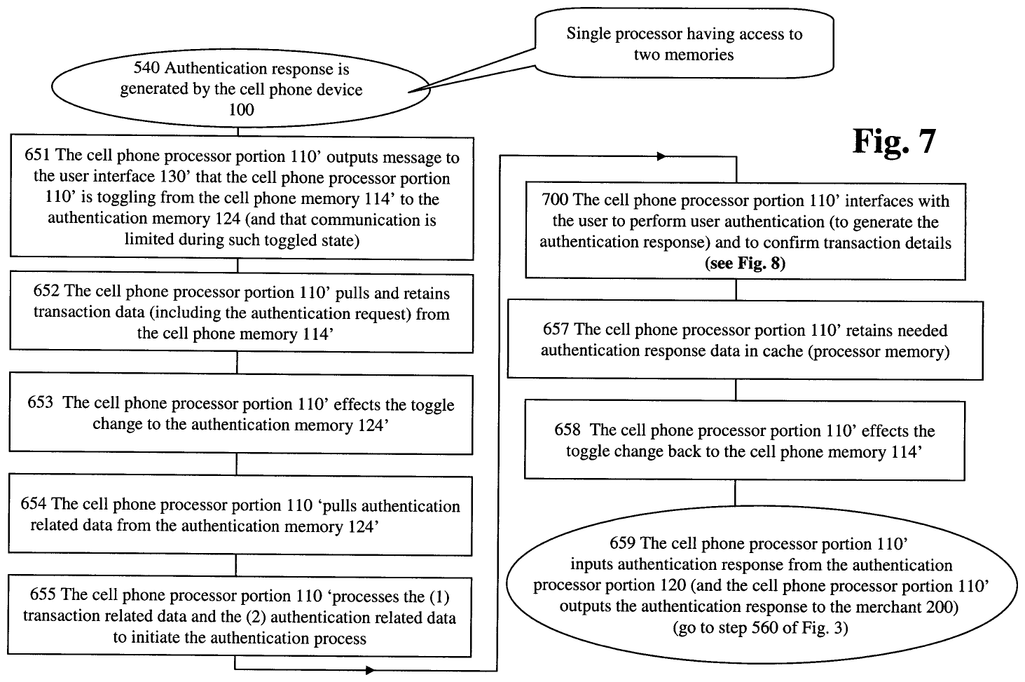

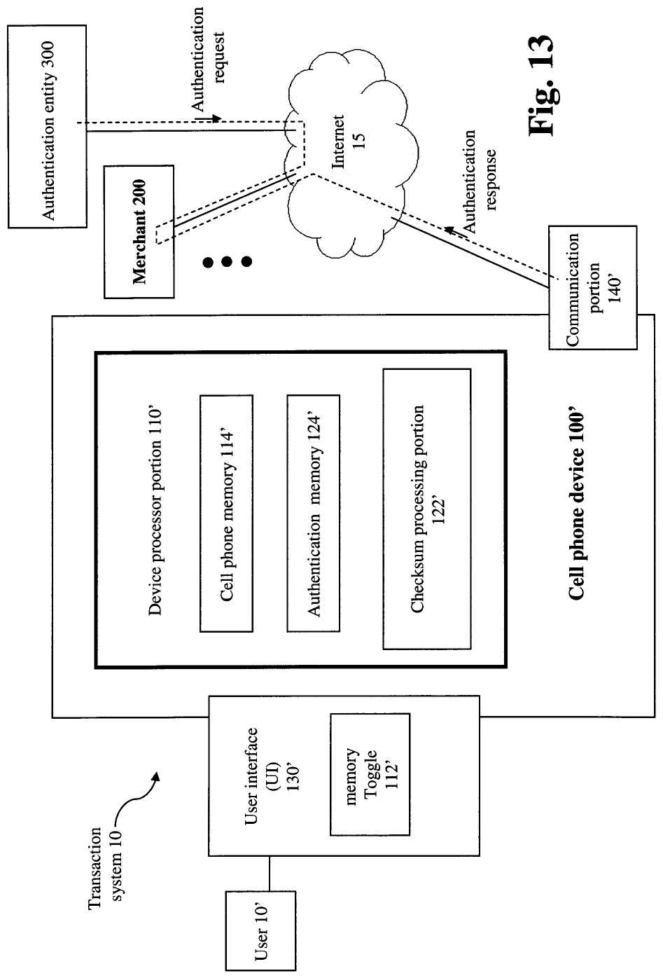

FIG. 7 is a flowchart showing further details of the “generation of an authentication response” step of FIG. 3, in accordance with a yet further embodiment of the invention. The example of FIG. 7 relates to a single processor having access to two memories. That is, the process of FIG. 7 may be performed by the transaction system 10′ of FIG. 13. As shown in FIG. 13, the cell phone processor portion 110′ includes both a cell phone memory 114′ and an authentication memory 124′.

The process of FIG. 7 starts in step 540, and passes to step 651.

In step, 651 the cell phone processor portion 110′ outputs a message to the user interface 130 that the cell phone processor portion 110′ is toggling from the cell phone memory 114′ to the authentication memory 124′ (and that communication is limited during such toggled state). In step 652, the cell phone processor portion 110′ pulls and retains transaction data (including the authentication request) from the cell phone memory 114′. In step 653, the cell phone processor portion 110′ effects the toggle change to the authentication memory 124′. In accordance with a different embodiment of the invention, the user 10 might physically effect the toggle change, e.g. via a switch that the user manipulates.

After step 653 of FIG. 7, the process passes to step 654. In step 654, the cell phone processor portion 110′ pulls authentication related data from the authentication memory 124′. Then, in step 655, the cell phone processor portion 110′ processes the (1) transaction related data and the (2) authentication related data to initiate the authentication process.

In step 700, the cell phone processor portion 110′ interfaces with the user to perform user authentication (to generate the authentication response) and to confirm transaction details (as described below with reference to FIG. 8).

Then, in step 657, the cell phone processor portion 110′ retains needed authentication response data in cache (processor memory). In step 658, the cell phone processor portion 110′ effects the toggle change back to the cell phone memory 114′. Then, in step 658, the cell phone processor portion 110′ outputs an authentication response to the merchant 200. The process then goes to step 550′ of FIG. 3.

It is appreciated that while not shown, device authentication, as described further below, may also be used in conjunction with the processing of FIG. 7.

FIG. 8 is a flowchart showing further details of the “interface with a user” processing of FIGS. 4-6, respectively, in accordance with an embodiment of the invention. The process starts in step 700, and passes to step 702.

In step 702, the secure processor portion 120 outputs a message to user 10 prompting input of PIN information, for example. Then, in step 704, the secure processor portion 120 receives the PIN from the user. It is appreciated that other authentication data may be input from the user 10 and/or used in the process in FIG. 8, as desired.

After step 704, the process passes to step 705. In step 705, the secure processor portion 120 presents an amount of the requested transaction (and other particulars of transaction) to user 10. In step 706, the secure processor portion 120 inputs confirmation from user that the particulars of transaction are correct. On the other hand, if the particulars are not correct, then appropriate action may be taken, such as restarting the desired transaction.

Then, the process passes to step 708. In step 708, the process returns to the respective higher level processing of FIG. 4, 5, or 6.

FIG. 9 is a flowchart showing further details of the “perform device authentication related processing” of either of FIG. 3, in accordance with an embodiment of the invention. The processing of FIG. 9 starts in step 800, and passes to step 810.

In step 810, the checksum processing portion 122 reads a checksum authentication query (CAQ), received from the authentication entity 300, to determine the data to check to perform the authentication query (CAQ).

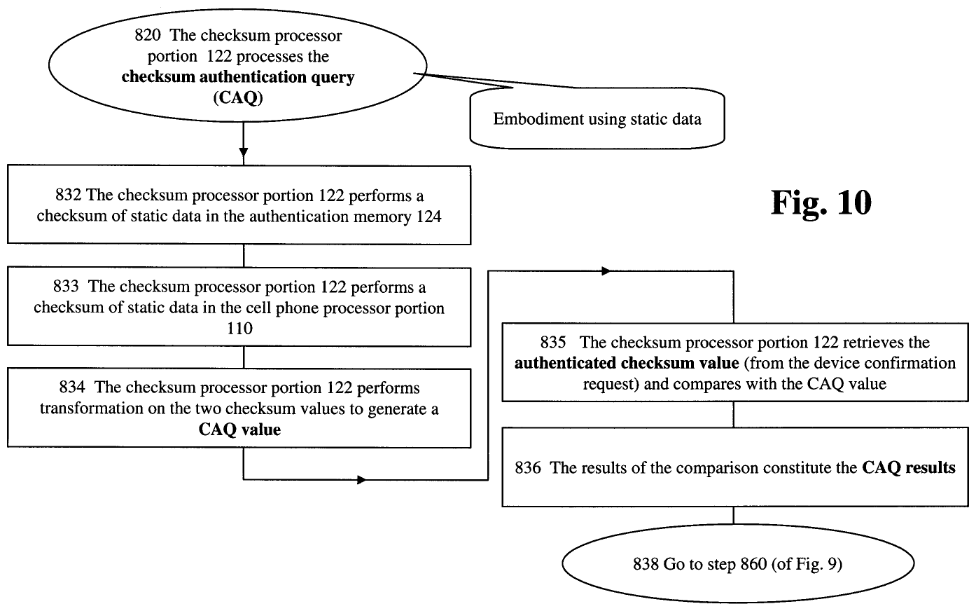

Then, in step 820, the checksum processing portion 122 processes the checksum authentication query (CAQ). FIGS. 10-12, as described below, provide respective embodiments of such processing. Then, the process passes to step 860.

In step 860, the checksum processing portion 122 attaches the results of the checksum authentication query (CAQ) (i.e., a CAQ value that was generated in the processing of step 820) to the authentication response. Then, the process passes to step 870. In step 870, the process returns to the respective higher level processing of FIG. 4, 5, or 6.

FIG. 10 is a flowchart showing further details of the “processing of a checksum authentication query” processing of FIG. 9, in accordance with a further embodiment of the invention. In particular, in FIG. 10, the checksum processing portion 122 processes the checksum authentication query (CAQ) using static data in the cell phone device 100.

The processing of FIG. 10 starts in step 820, and passes to step 832. In step 832, the checksum processing portion 122 performs a checksum of static data in the secure processor portion 120. Then, in step 833, the checksum processing portion 122 performs a checksum of static data in the cell phone processor portion 110. Any suitable data may be used. Then, in step 834, the checksum processing portion 122 performs transformation on the two checksum values to generate a CAQ value. For example, the checksum processor portion 122 might simply add the values together, or perform some other operation on the values. Alternatively, the process may just use one and/or the other checksum. Then, in step 835, the checksum processing portion 122 retrieves the authenticated checksum value (from the authentication request) and compares with the CAQ value. As reflected in step 836, the results of the comparison constitutes the CAQ results. Then, in step 838, the process goes to step 860 (of FIG. 9).

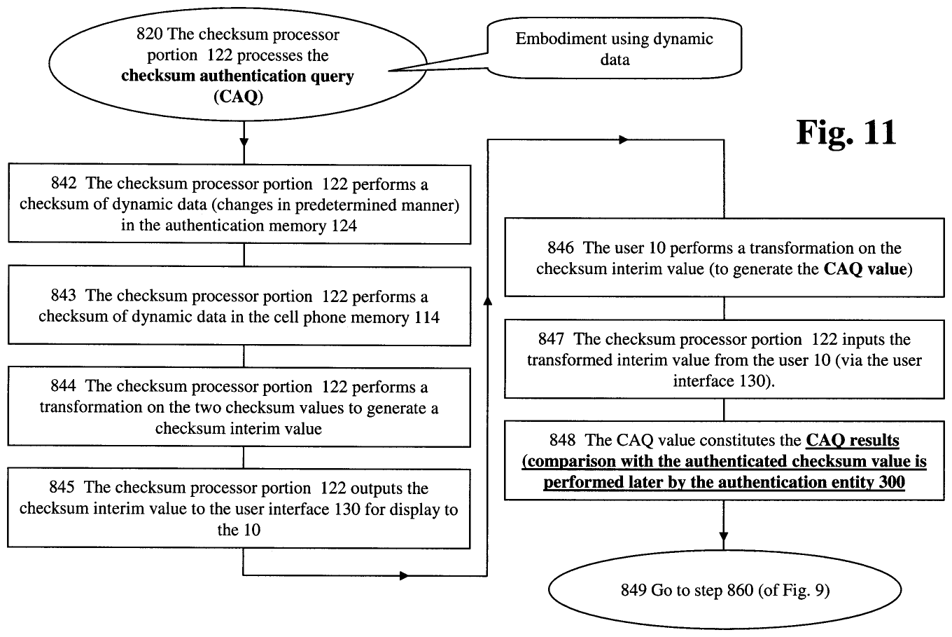

FIG. 11 is a flowchart showing further details of the “processing of a checksum authentication query” processing of FIG. 9, in accordance with a yet further embodiment of the invention. In particular, in FIG. 10, the checksum processing portion 122 processes the checksum authentication query (CAQ) using dynamic data in the cell phone device 100.

The processing of FIG. 11 starts in step 820, and passes to step 842. In step 842, the checksum processing portion 122 performs a checksum of dynamic data in the authentication memory 124. That is, such “dynamic data” changes in a predetermined way, so as to be reproducible by the authentication entity 300, for example. For example, such changing data might simply result from the advancement of a clock.

Then, in step 843, the checksum processing portion 122 performs a checksum of dynamic data in the cell phone memory 114. In step 844, the checksum processing portion 122 performs a transformation on the two checksum values to generate a checksum interim value. Then, in step 845, the checksum processing portion 122 outputs the checksum interim value to the user interface 130 for display to the user 10. Then, the process passes to step 846.

In step 846, the user 10 performs a yet further transformation on the checksum interim value (i.e., to generate the CAQ value). Then, in step 847, the checksum processing portion 122 inputs the transformed interim value from the user 10 (via the user interface 130).

As reflected in step 848, the CAQ value constitutes the CAQ results. In this example, comparison with an authenticated checksum value is performed later by the authentication entity 300. Then—the process passes to step 849.

Then, in step 838, the process goes to step 860 (of FIG. 9).

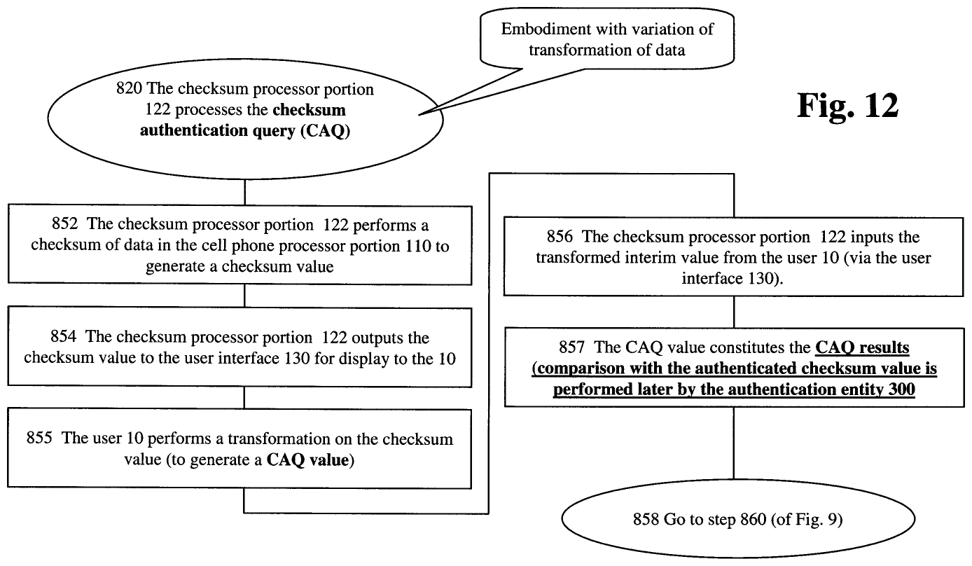

FIG. 12 is a flowchart showing further details of the “processing of a checksum authentication query” processing of FIG. 9, in accordance with a yet further embodiment of the invention. In particular, FIG. 12 shows a variation on the transformation of a checksum value. The process of FIG. 12 starts in step 820, and passes to step 852.

In step 852, the checksum processing portion 122 performs a checksum of data in the cell phone processor portion 110 to generate a checksum value. Then, in step 854, the checksum processing portion 122 outputs the checksum value to the user interface 130 for display to the 10. Then, the process passes to step 855.

In step 855, the user 10 performs a transformation on the checksum value (to generate a CAQ value). The transformation is in the form of some predetermined manipulation of the checksum value, which is reproducible by the authentication entity 300. Then, in step 856, the checksum processing portion 122 inputs the transformed interim value from the user 10 (via the user interface 130). Then, the process passes to step 857.

In step 857, the CAQ value is processed to constitute the CAQ result. The comparison with an authenticated checksum value may then be performed later by the authentication entity 300.

Then, in step 838, the process goes to step 860 (of FIG. 9).

In accordance with embodiments of the invention, the checksum comparison, as described herein, may be preferred to be done at the back end (i.e., on some backend system such as the authentication entity 300), and not on the cell phone. That is, the cell phone, in processing, just returns information to the back end which compares to what is expected. (The cell phone is not considered trustworthy unless this matches, and a hacked cell phone would just reply “sure, all is well and checksums compare” if it were left to such a device to do the comparison.). In other words, if performing a checksum of the cellphone memory, the comparison may be preferred to happen at the back end, though the program that computes cell memory checksum sits somewhere on the phone. The program sitting on the cell phone is told by the backend system where to start and end, and can be trusted adequately for such processing. However, in other embodiments, the comparison might indeed be performed on the device, e.g. the cell phone.

As described herein, the checksum processing, i.e., the cryptographic hash function, is used to check a block of memory in the cell phone. That is, there may be a block of memory from, say, 0 to 10000, for example. The processing as described herein asks for a hash of that block, i.e., applies a cryptographic hash function to the block. The hash value may be in the form of a single number. Note though that a single value for an entire block might be precomputed by a virus or worm program. For that reason it is best to break up memory areas needing to be checked, at variable spots which will be hard for a worm program to predict, and ask for separate checks on memory ranges which cover the desired range.

Regarding performing checksum processing on variable spots, i.e., variable boundaries, the authentication entity 300 (for example) may dictate the particular boundaries to check between. As the number of ranges defined by the boundaries increases, the complexity increases, as does the difficulty in trying to fraudulently create the correct checksum. Further, the regions that are checked may indeed overlap. Such overlapping adds further difficulty in trying to fraudulently create the correct checksum.

As used herein, the terms “data ” and “information” have been used interchangeably.

Accordingly, in accordance with one embodiment of the invention, multiple ranges in the cell phone memory may be used in the cryptographic hash function. Specifically, two or ore ranges might be used. Further, the ranges might be overlapping.

That is, for example, the invention may include breaking the ranges into two overlapping, ranges, like 0-4534 and 4200-10000, and computing the hashes for each of those. Indeed, the processing may include breaking the address or addresses anywhere in the memory, and computing hash values for such addresses. Such processing makes it necessary for a worm (or other fraudulent device) to have substantial precomputed results to get the answers right. Further, the address(s) used, as well as the breaks in those addresses, may be easily changed at the back end, i.e., at the authentication entity 300.

As described above, FIGS. 1, 2 and 13 show embodiments of structure and system of the invention. Further, FIGS. 3-12 show various steps in accordance with one embodiment of the invention. It is appreciated that the systems and methods described herein may be implemented using a variety of technologies. Hereinafter, general aspects regarding possible implementation of the systems and methods of the invention will be described.

It is understood that the system of the invention, and portions of the system of the invention, may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A method of authenticating that memory of a remote device contains known processing code, in conjunction with performing a financial transaction, the remote device operated by a customer, the method performed by a tangibly embodied processor, the method including:
receiving, by the processor, transaction data from the remote device, the transaction data related to a requested financial transaction;
receiving device identification information, by the processor, from the remote device;
selecting, by the processor, at least one query, based on the device identification information, the query comprising instructions to check the processing code in the remote device for performing a validity test;
sending, by the processor, the at least one query to the remote device the query comprising one or more cryptographic hash functions and a request for a one or more cryptographic checksums of the processing code in a relevant section memory of the device, wherein the relevant section of memory is determined based at least in part on the device identification information, and wherein the one or more cryptographic hash functions specify variable boundaries of at least a part of the memory of the device upon which the cryptographic hash function is performed, and the number of cryptographic checksums requested totals one more than the number of variable boundaries specified and where the one or more cryptographic hash functions request the one or more cryptographic checksums between one of a fixed boundary and a variable boundary, and two variable boundaries, said cryptographic hash function, and variable boundaries, being computed by the processor based at least in part on the device identification information;
receiving, by the processor, a query response, which constitutes a response to the query, from the remote device;
performing the validity test by processing the query response with an expected query response to determine whether the query response and the expected query response match; and
based on the processing, determining, by the processor, whether the validity test is passed, and
outputting, by the processor, approval of the requested financial transaction if the validity test is passed; or
outputting, by the processor, disapproval of the requested financial transaction if the validity test is not passed.

2. The method of claim 1, wherein the known processing code is software.

3. (canceled)

4. (canceled)

5. The method of claim 1, wherein the at least a part of the memory is constituted by a portion of memory between memory addresses, the memory addresses included in the query.

6. The method of claim 5, wherein the at least a part of the memory is constituted by a plurality of portions of memory, each disposed between two respective memory addresses, the memory addresses included in the query.

7. The method of claim 1, wherein the expected response is constituted by software configuration of an untampered-with remote device.

8. The method of claim 1, wherein:
the query is constituted by a reading of memory to generate read memory, and
the processing the query response with an expected query response includes comparing the read memory with memory of an untampered-with remote device.

9. The method of claim 1, wherein the query is constituted by a set of instructions that are to be executed on the remote device, so as to generate the query response.

10. The method of claim 1, wherein the remote device is a cell phone.

11. The method of claim 1, further including performing customer authentication subsequent to the authentication of the remote device.

12. A method for authenticating in conjunction with the use of a remote device of a customer, the remote device including a secure processor, the method comprising:
generation by the secure processor of a display in a display portion, the display containing a plurality of glyphs, the generation using processing known to a remote authenticator system, the secure processor communicating with the display portion via a first transmission path;
inputting a customer selection made by the customer of some of the glyphs displayed using a pattern previously agreed on and known by the authenticator system;
transmitting the customer selection via a second transmission path to the remote authentication system,
repetition of the generation and selection of the glyphs by the remote authentication system so as to generate a comparison selection, and
performing a comparison of the customer selection vis-á-vis the comparison selection, so as to authenticate the customer selection; and
outputting results from the comparison.

13. The method of claim 12, wherein the glyphs include at least one of (digits, letters, signs, or the like

14. The method of claim 12, wherein the first transmission path is a trusted path.

15. The method of claim 12, wherein the first transmission path is a trusted path.

16. The method of claim 12, wherein the method is performed to authenticate the user of the remote device.

17. The method of claim 12, wherein the remote device is one of a cell phone and a PDA.

18. A method for authenticating a requested transaction effected by a user device, the method including:
receiving an authentication request from an authentication entity, the authentication request dictating a checksum operation to be performed on particular data in the user device;
performing the checksum operation on the particular data, so as to generate a checksum authentication query value (CAQ value);
comparing the CAQ value with an authenticated checksum value; and
generating an authentication determination, based on the comparing, so as to authenticate the requested transaction.

19. The method of claim 18, wherein the user device is a cell phone.

20. The method of claim 18, wherein the performing the checksum operation on the particular data, so as to generate the CAQ value further includes generating a checksum interim value, and performing a transformation on the checksum interim value, so as to generate the CAQ value.

21. The method of claim 18, wherein the checksum operation on the particular data is performed on static data in the device.

22. The method of claim 18, wherein the checksum operation on the particular data is performed on dynamic data in the device.

23. The method of claim 1, further including the user device having two processor portions, including:
a cell phone processor portion for handling communications performed by the user device; and
a secure processor portion for handling authentication processing performed by the user device.

24. The method of claim 23, wherein the user device further includes both a first user interface and an authentication interface.

25. The method of claim 24, wherein
the cell phone processor portion is associated with the first interface for interfacing with a user, and
the secure processor portion is associated with the authentication interface for interfacing with a user.

26. The method of claim 24, wherein the user device includes a toggle to control whether the first user interface or the authentication interface is active.

27. The method of claim 26, wherein the toggle is controlled by the user device.

28. The method of claim 26, wherein the toggle is controlled by the user.

29. A system for authenticating that memory of a remote device matches a known processing code, in conjunction with performing a financial transaction, the remote device operated by a customer, the system comprising:
a communications portion, constituted by a first non-transitory processor, programmed to receive transaction data from the remote device, the transaction data related to a requested financial transaction, the communications portion inputting device identification information from the remote device; and
a processing portion, constituted by a second non-transitory processor, disposed in an authentication entity, the processing portion programmed to:
select at least one query, based on the device identification information, the query comprising instructions to check processing code in the remote device for performing a validity test;
send, by the processor, the at least one query to the remote device the query comprising one or more cryptographic hash functions and a request for a one or more cryptographic checksums of the processing code in a relevant section memory of the device, wherein the relevant section of memory is determined based at least in part on the device identification information, and wherein the one or more cryptographic hash functions specify variable boundaries of at least a part of the memory of the device upon which the cryptographic hash function is performed, and the number of cryptographic checksums requested totals one more than the number of variable boundaries specified and where the one or more cryptographic hash functions request the one or more cryptographic checksums between one of a fixed boundary and a variable boundary, and two variable boundaries, said cryptographic hash function, and variable boundaries, being computed by the processor based at least in part on the device identification information;
receive a query response, which constitutes a response to the query, from the remote device;
perform the validity test by processing the query response with an expected query response to determine whether the query response and the expected query response match; and
based on the processing, determine whether the validity test is passed, and
output approval of the requested financial transaction if the validity test is passed; or
output disapproval of the requested financial transaction if the validity test is not passed.

30. A system for authenticating a requested transaction effected by a user
device, the system comprising:
a communications portion receiving an authentication request from an authentication entity, the authentication request dictating a checksum operation to be performed on particular data in the user device; and
a processing portion in communication with the communications portion, the processing portion:
performing the checksum operation on the particular data, so as to generate a checksum authentication query value (CAQ value);
comparing the CAQ value with an authenticated checksum value; and
generating an authentication determination, based on the comparing, so as to authenticate the requested transaction.

31. (canceled)
